(19) United States
(12) Patent Application Publication
(10) Pub. No.: US 2023/0191408 A1
(43) Pub. Date: Jun. 22, 2023

(54) FLUIDIC COMPONENT AND FLUIDIC ACCESS CONTROL DEVICE

(71) Applicant: Commissariat à l'Energie Atomique et aux Energies Alternatives, Paris (FR)

(72) Inventors: Guillaume BLAIRE, Grenoble Cedex 9 (FR); Manuel ALESSIO, Grenoble Cedex 9 (FR); Mélissa BAQUE, Grenoble Cedex 9 (FR); Jean-Maxime ROUX, Grenoble Cedex 9 (FR)

(73) Assignee: Commissariat à l'Energie Atomique et aux Energies Alternatives, Paris (FR)

(21) Appl. No.: 18/065,023

(22) Filed: Dec. 13, 2022

(30) Foreign Application Priority Data
Dec. 17, 2021 (FR) 21 13754

(51) Int. Cl. B01L 3/00

(52) U.S. Cl. CPC B01L 3/502738; B01L 2400/0677; B01L 2300/1827; B01L 2300/0645; B01L 2300/123

(57) ABSTRACT

A fluidic component including a fluidic circuit having at least one fluidic access through which a fluid is intended to pass, an actuator capable of expanding, a deformable membrane that can be actuated by the expansion of the actuator, sealing device for sealing off the fluidic access and including at least a body made of a meltable compound configured to adopt two states: a solid first state, a molten second state obtained under the effect of an increase in temperature, the body of meltable compound being designed to be moved in the molten state, by the expansion of the actuator, between a standby position and a distinct sealing-off position for sealing off the fluidic access.

### TECHNICAL FIELD OF THE INVENTION

The present invention relates to a fluidic component and to a fluidic access control device. The device may notably comprise a reaction chamber, that can be isolated during the course of the reaction and sealed after the reaction, using various fluidic valve mechanisms.

### PRIOR ART

Microfluidic devices formed of a microfluidic network of microfluidic capsules and of channels connecting the capsules to one another are known from documents US2012/064597A1, US2013/130262A1, US2007/166199A1 and US2006/076068A1. Each microfluidic capsule comprises a chamber into which an inlet channel opens and from which an outlet channel emerges. A deformable membrane is commanded between two positions to confer two distinct states on the capsule: a first state in which the inlet channel communicates with the outlet channel via the chamber, allowing the transfer of fluid, and a second state in which the membrane blocks the communication between the two channels, preventing the flow of fluid and preventing the filling of the chamber of the capsule. The membrane is commanded between its two positions using pneumatic means, for example by applying a positive pressure or negative pressure to it. In order to produce these devices, the known solutions are performed using a multilayer assembly in which the deformable membrane forms an intermediate layer sandwiched between two substrates. The membrane is often bonded, clamped between two layers, or fixed using a pre-cut double-sided sticky tape. In these documents, the microfluidic capsules are incorporated into microfluidic cards or cartridges which have pneumatic connectors so that they can be connected to external pressure sources and regulators. One disadvantage with these solutions is the need to provide a leak-free air or fluid connection between the microfluidic card incorporating the capsules and the pressure sources. Another disadvantage is the noise produced by the pumps or compressors generally used as pressure sources. One alternative to the pumps and compressors is to use a gas cartridge but the pressure produced needs to be regulated and, what is more, the use of such pressure sources may be subject to regulations such as, for example, for transport by aeroplane.

Patent application EP3326717A1 proposes another solution in which the valve is created by adding to a cavity a liquid that is intended to form an element made of deformable material. The actuating mechanism of the invention is commanded by a command and processing unit to deform the deformable-material element of each capsule, for example by applying a pressure or a pressure pulse by means of a pressurizing fluid, particularly a pressurizing gas, via the actuating holes of each capsule. The command and processing unit is managed by a plurality of software modules, each software module corresponding to one or more of the steps of the method. In this invention, the pressurizing source is not described, but command by a plurality of modules proves to be complex.

These various valve solutions are pneumatically actuated and require complex external means to actuate them. These means generally comprise external pumps or compressors as pressure sources, pressure regulators, and sometimes also electrically-operated valves. These means are external to the microfluidic devices which means that fluidtight pneumatic connections need to be provided. Furthermore, these means need to be commanded and regulated by dedicated mechanisms or else operated by electronic circuits and possibly software.

The reference document “Closable Valves and Channels for Polymeric Microfluidic Devices” (P. Clark &al, 2020) describes three novel approaches for closing-off valves. The first approach consists of a chamber contiguous with the channel that is to be closed and in which the component parts of an expanding foam are mixed. The reaction produced by this mixing causes the foam to expand and seal off the channel. This approach does indeed allow passive sealing once the valve has been actuated, but on the other hand does require a complex fluidic architecture in order to achieve the mixing of the component parts of the foam and in order to load these reagents. In addition, the time needed for the chemical reaction used is of the order of ten minutes or so, which is long and does not allow a reaction chamber to be sealed off in order to avoid any risk of dispersal in the event of ill-timed removal of the device by the operator. The other two approaches in the document are based on the either thermal or chemical melting of a layer of polymer pierced with a hole. It is through this hole that the liquid passes when the valve is open. By heating and applying a controlled pressure to the layer around the hole (second approach) or by applying a chemical product able to dissolve the layer around the hole (third approach), the layer is locally melted, and the polymer which has become liquid will coalesce and plug the hole as it cools. In these two approaches, the operating conditions are complex to incorporate into a device. In the case of the thermal approach, it is effectively necessary to achieve temperatures well in excess of 100° C., which is somewhat incompatible with the loading of temperature-sensitive reagents such as enzymes used for example in reactions of the biomolecular type. In the case of the chemical approach, it is relatively complex to incorporate a solvent capable of dissolving a polymer layer into a device made chiefly of polymer.

Patent application WO2007/044917A2 also describes a fluidic valve architecture.

Moreover, it was not necessarily easy to achieve a solution capable both of isolating a fluidic chamber in which a reaction occurs, while the reaction is taking place, and of sealing this reaction chamber once the reaction is over, to avoid any dispersal of the products of the reaction, including in the event of a handling error, or else in the event of software, mechanical or electronic errors. Specifically, valves are generally monostable, which is to say that they require an operating signal to be sustained in order for them to remain in a defined position. Thus, they are not necessarily well suited to sealing a chamber definitively, in the absence of a command.

Moreover, it may prove relevant to have a fluidic component that incorporates a fluidic valve mechanism that can be rapidly deployed in the field.

It is a first objective of the invention first of all to propose a fluidic component that meets this need.

It is a second objective of the invention to propose a device, suitable for example for managing fluidic access to a chamber, whether this be for temporarily isolating it or for sealing it off almost irreversibly.

### SUMMARY OF THE INVENTION

This first objective is attained by a fluidic component comprising:
A fluidic circuit having at least one fluidic access through which a fluid is intended to pass,
Actuating means capable of expanding,
A deformable membrane that can be actuated by the expansion of said actuating means and that is configured to move between a first position in which it allows the fluid to pass through the fluidic access and a closure second position in which it blocks the passage of the fluid through the fluidic access,
Sealing means for sealing off the fluidic access and comprising at least a body made of a meltable compound configured to adopt two states:
   A solid first state,
   A molten second state obtained under the effect of an increase in temperature,
Said body of meltable compound being designed to be moved in the molten state, by the expansion of the actuating means, between a standby position and a distinct sealing-off position for sealing off the fluidic access.

According to one special feature, the actuating means capable of expanding comprise a fluidtight reservoir filled with a volume of air, collaborating via a fluidic passage with the membrane.

According to another special feature, the actuating means comprise a bubble of gas able to expand and trapped in a location by said body made of meltable compound.

According to another special feature, the fluidic passage is initially blocked by the body made of meltable compound present in its solid first state and in its standby position.

According to another special feature, in its sealing-off position, the body made of meltable compound is deposited on a face of the membrane which is the opposite face to a face that closes off the fluidic access.

According to another special feature, the component is produced in the form of a one-piece element.

According to another special feature, the membrane is made from a material of the elastomer type.

According to another special feature, the meltable compound is a paraffin selected from docosane, tricosane, tetracosane, pentacosane, hexacosane and octacosane.

The second objective of the invention is attained by a fluidic device comprising:
A fluidic component as defined hereinabove,
Heating means designed to:
   Heat said body made of meltable compound to a temperature sufficient to cause it to pass from its first state to its second state
   Expand said actuating means, causing the membrane to deform from its first position to its second position and causing the body made of meltable compound to move, in its second state, toward the position for sealing off the fluidic access.

According to one special feature the fluidic circuit comprises a reaction chamber and the heating means are designed to perform heating both of:
Said reaction chamber in order to perform a detection reaction, and
Of said body made of meltable compound to a temperature sufficient to cause it to pass from its first state to its second state,
And to expand said actuating means, causing the membrane to deform from its first position to its second position and causing the body made of meltable compound to move, in its second state, toward the position for sealing off the fluidic access.

Advantageously, the heating module comprises at least two resistive branches in parallel, each one configured to exhibit a distinct electrical resistance, the first resistive branch being dedicated to providing a first thermal power and the second resistive branch being dedicated to supplying a second thermal power, said first thermal power being higher than the second thermal power.

According to another special feature, the heating module comprises at least two resistive branches in series, each one configured to exhibit a distinct electrical resistance, the first branch being dedicated to providing a first thermal power and the second branch dedicated to supplying a second thermal power, distinct from the first thermal power.

The invention also relates to an analysis method implemented in a fluidic device as defined hereinabove, said method consisting in activating the heating means to a temperature sufficient to at once:
Implement a detection reaction in said reaction chamber,
Actuate the membrane toward its closure position in order to isolate the reaction chamber during said detection reaction,
   Initiate a sealing-off of the reaction chamber by the melting of the body made of meltable compound and the movement of said body in the molten state toward its sealing-off position.

It should be noted that splitting the heating module into at least two resistive branches advantageously allows two distinct thermal powers to be supplied to the different components of the device, the better to sequence the method.

### BRIEF DESCRIPTION OF THE FIGURES

Other features and advantages will become apparent from the following detailed description, which is given with reference to the appended drawings, in which:

FIG. 1 is a schematic view of the fluidic access device according to the invention, from above;

FIG. 2 illustrates the principle of operation of the first fluidic valve mechanism employed in the device of the invention;

FIG. 3 illustrates the principle of operation of the second fluidic valve mechanism employed in the device of the invention;

FIGS. 4A to 4C illustrate, in a number of views, the principle of operation of the device according to the invention;

FIGS. 5A to 5C depict a variant embodiment of the device according to the invention and illustrate the principle of operation thereof;

FIG. 6 shows an advantageous embodiment of the heating module used in the fluidic valve type device of the invention.

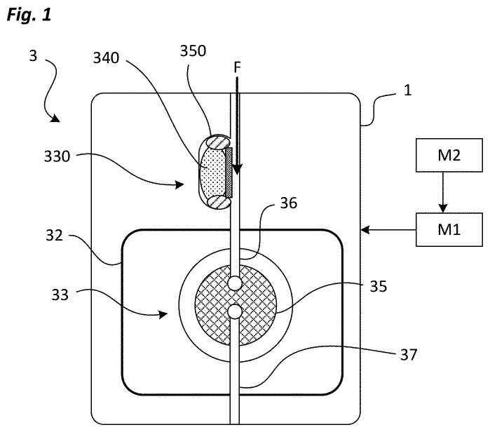

### DETAILED DESCRIPTION OF AT LEAST ONE EMBODIMENT

In the remainder of the description, the terms “upstream” and “downstream” are to be understood with regard to the direction in which the fluid circulates in the fluidic circuit concerned.

In the remainder of the description, in a fluidic valve mechanism, a valve in the open state allows the fluid to pass (state 1 or ON) and a valve in the closed state blocks the passage of the fluid (state 0 or OFF).

With reference to the figures, the invention is aimed at a device 3, 4 intended to control the fluidic access, for example to a reaction chamber 30 (see hereinafter), this device being able to isolate the access and even to seal off this access.

The fluidic part of the device is produced in a fluidic component 1, 10. The fluidic component 1, 10 may take the form of a single one-piece element. This element may be produced by superposing and assembling several layers.

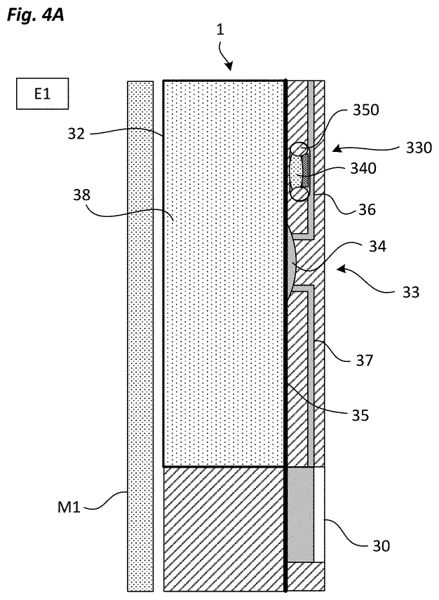

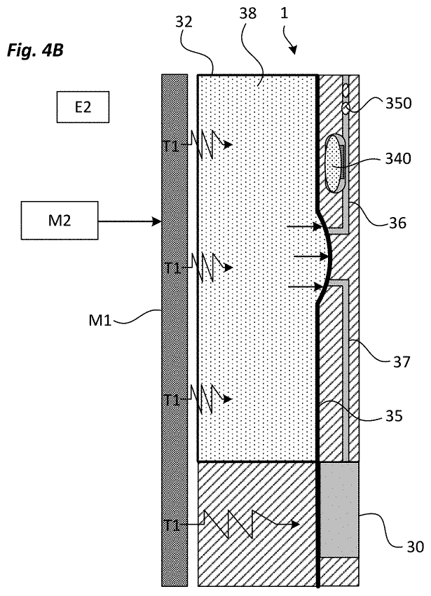

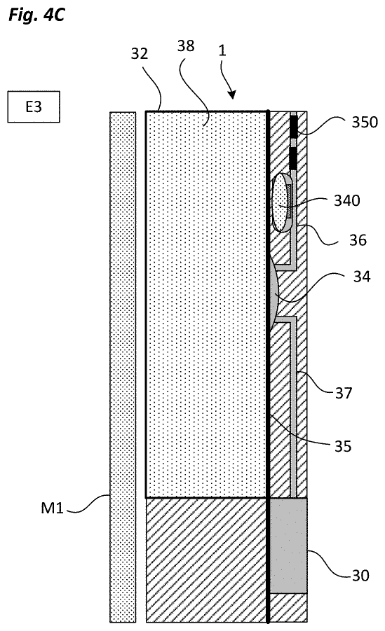

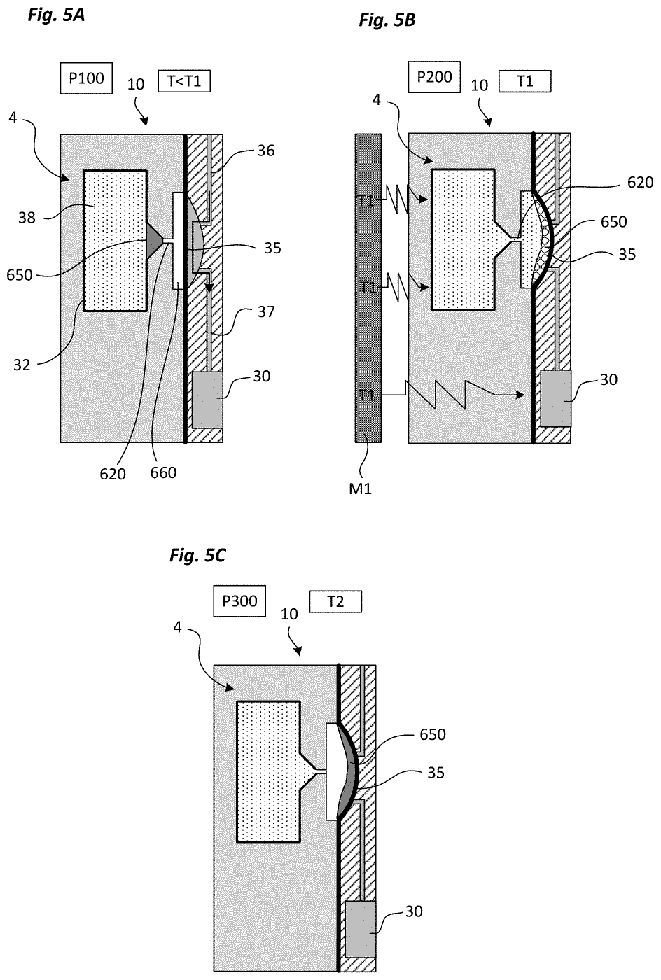

The device 3, 4 may be produced according to two embodiment variants respectively depicted in FIGS. 4A to 4C in the case of the first embodiment variant, and FIGS. 5A to 5C in the case of the second embodiment variant.

In general, the device uses a deformable membrane 35 that can be actuated in order to close the fluidic access, sealing-off means capable of sealing off the fluidic access and actuating means capable of expanding in order both to actuate the membrane and to act on the sealing-off means.

The actuating means may comprise at least one fluidtight reservoir of gas, for example air, incorporated into the microfluidic component.

The sealing-off means advantageously use at least one body 350, 650 made of a meltable compound, for example a paraffin.

The device also comprises a heating module M1 that is controlled in such a way as to:
Melt the body 350, 650 made of meltable compound,
Expand the actuating means in order thus to cause the membrane to move so as to close the fluidic access and to encourage the body 350, 650 made of meltable compound to move, in the molten state, toward a position in which it is able to seal off the fluidic access once it has returned to a solid state.

This closure and this sealing-off are achieved by controlling the heating module M1 to heat to a temperature high enough to both cause the deformation of the membrane and the melting of the meltable compound. This temperature is referred to hereinbelow as T1. The sealing-off then obtained when the meltable compound returns to its solid state, which is to say when the temperature drops back sufficiently, for example to a value T2 which is lower than T1.

In an embodiment variant of the device, the meltable compound, when it returns to the solid-state:
Directly obstructs the fluidic access and plugs a channel, directly closing the fluidic access;
Keeps the membrane in the closure position, thus indirectly keeping the fluidic access in the closed state;

The heating module M1 advantageously incorporates an electrical power supply and employs a control module M2.

It should also be noted that the heating module M1 may be incorporated into a support onto which said fluidic component 1, 10 fits, so that the component 1, 10 comes in the form of an easily replaceable consumable. The support is then a mechanical assembly distinct from the component 1.

In a variant, the heating module M1 may be at least partially incorporated into said element forming the component 1, 10. In the latter instance, by way of example, a resistance may be incorporated into the body of the component 1, 10, said component 1, 10 then fitting onto a support in order to connect said resistance to an external electrical power supply.

The control module M2 is configured to control the heating module M1 with a view to adjusting and regulating the applied temperature.

According to one particular aspect of the invention, it is possible to create an entirely stand-alone marker, it being possible for the heating module M1 to be external, or incorporated into the component or assembled therewith, the same being true of the control module M2.

In the first variant, the fluidic component 1 of the device 3 has the special feature of having two distinct fluidic valve mechanisms 33, 330, one for temporarily isolating the fluidic access and the other for sealing off the fluidic access.

The two fluidic valve mechanisms are for example arranged on the one same fluidic channel for controlling the flow of fluid through this channel.

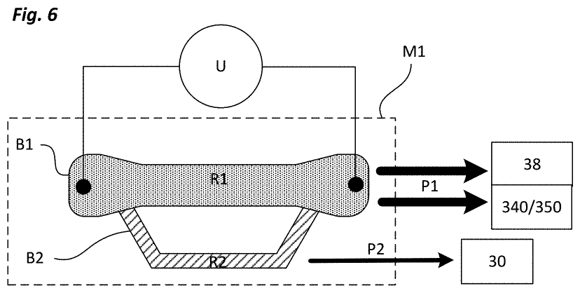

According to one particular aspect, these two fluidic valve mechanisms both employ thermal actuation. This thermal actuation may be achieved by means of the heating module M1 described hereinabove and belonging to the device. The heating module M1 may be common to the two mechanisms and capable of supplying heat at a given and precise temperature and of supplying one or more distinct thermal powers (see embodiment of FIG. 6).

The device may also comprise a control module M2 configured to control the heating module M1 with a view to adjusting and regulating the applied temperature.

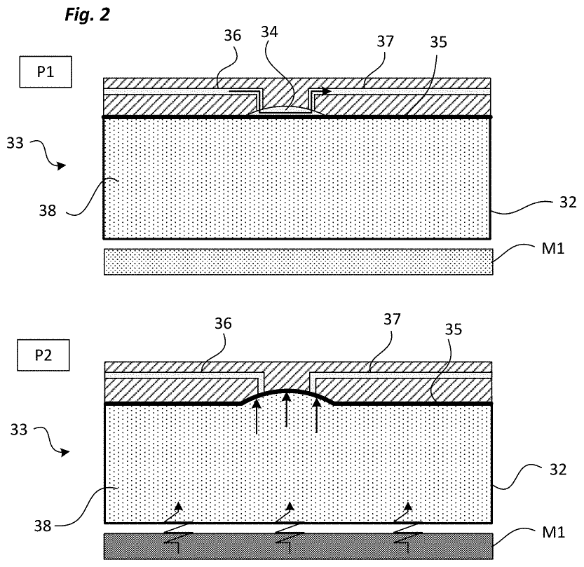

FIG. 2 illustrates the principle of operation of the first fluidic valve mechanism 33 employed in the device 3.

With reference to FIG. 2, the first fluidic valve mechanism 33 is intended to be arranged on a fluidic circuit to control the passage of a fluid F in this fluidic circuit. In simplified terms, the first fluidic valve mechanism 33 is arranged between an inlet channel 36 and an outlet channel 37 of the fluidic circuit.

The actuating means capable of expanding and which are used in the first fluidic valve mechanism 33 for example take the form of at least one fluidtight reservoir 32 intended to contain an expandable volume, for example air 38.

The first fluidic valve mechanism 33 comprises a space 34 into which the inlet channel 36 opens and from which the outlet channel 37 emerges, the volume of the space 30 for being variable according to the position of a deformable membrane 35 of the valve.

The membrane 35 is able to deform between an open first position in which the space 34 forms a passage for the fluid F between the inlet channel 36 and the outlet channel 37 of the controlled fluidic circuit (FIGS. 2—P1) and a closure position in which it blocks the passage of the fluid F in the controlled fluidic circuit (FIGS. 2—P2). In its closure position P2, the volume of the space 34 is thus zero or near-zero, the membrane 35 is being pressed intimately against a surface of an upper substrate, onto which surface the two channels open. Depending on its position, the membrane 35 is therefore able to modulate the volume of the space 34 of the fluidic valve mechanism 33.

In order to move the membrane 35 between its first position and its second position, the device comprises a heating module M1. The heating module M1 is designed and configured to heat the volume of air 38 placed in the reservoir 32 in order to cause this volume of air to expand. By expanding in the reservoir 32, the air pushes on the membrane 35, thus deforming it toward its closure second position (P2). The membrane 35 then obstructs the passage between the two channels 36, 37 in order to close the fluidic circuit by applying a pressure.

It should be noted that the reservoir 32 is closed in a fluidtight manner in the component.

It should be noted that the first fluidic valve mechanism 33 has reversible operation, insofar as the membrane 35 can be actuated from its first position to its second position and from its second position to its first position ad infinitum (within its mechanical limits).

The second fluidic valve mechanism 330 of the device is arranged on the same fluidic circuit as the first mechanism, for example upstream thereof on the fluidic channel 36 of the circuit.

The second fluidic valve mechanism 330 comprises at least one body 350 made of a meltable compound (two bodies 350 in the attached figures) initially trapping an element capable of expanding, in the channel 360 of the fluidic circuit concerned, for example a bubble of gas, advantageously a bubble of air 340, and forming said aforesaid actuating means. The small volumes of this meltable compound are deposited for example using a pipette, at intended locations on the edge of the channel concerned. The siting of the air bubble 340 between the two bodies 350 made of meltable compounds in each channel is also provided for in the microfluidic circuit. The air bubble 340 is at a location, in parallel with the fluidic channel and initially trapped in this location by the bodies 350 made of meltable material which are present in the solid state. These locations may be obtained for example by a machining using a milling cutter, or by laser etching, or else by the moulding of the circuit. The use of two bodies 350 notably makes it possible to ensure better operation of the device for sealing-off, but it must be understood that the invention remains functional with the use of just one body 350 made of meltable compound. In the latter instance, the air bubble 340 is trapped in its location by a one single body 350.

The meltable compound may be a linear alkane commonly referred to as a solid paraffin, the type of paraffin being selected according to the temperature at which the compound is to melt when the method is being implemented. The valve mechanism may notably be based to a large extent on the use of a paraffin capable at melting at a precise temperature, for example docosane (42-45° C.) or tetracosane (49-52° C.).

In order to initiate the second fluid valve mechanism 330, the device 3 also uses its heating module M1. The heating module M1 is arranged and configured to heat the meltable compound to a temperature at least equal to its melting-point temperature.

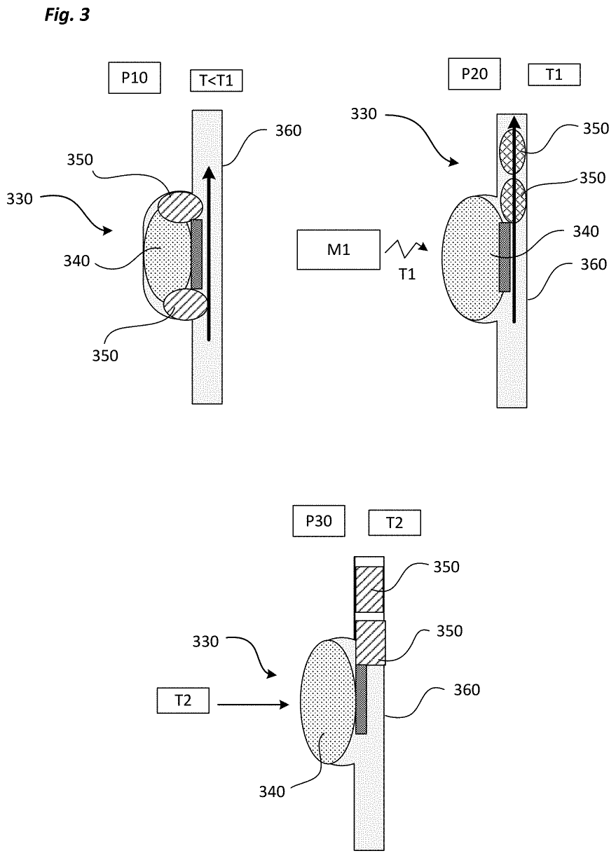

In connection with FIG. 3, the principle of operation of the second fluidic valve mechanism 330 is as follows:
Beneath its melting-point temperature (T1), the two bodies 350 remain trapped on the edge of the channel: the fluid can circulate freely (FIGS. 3—P10).
Above its melting-point temperature (at the temperature T1), the second meltable compound forming the two bodies 350 melts, the air bubble 340, which is pressurized on account of the heat, can expand, pushing the two molten bodies 350 along the channel. There is no pressure in the main channel other than the hydrostatic pressure, and the molten plugs, which are subjected to Archimedean upthrust and to capillary forces, remain liquid throughout the heating time. Experimentally, it is thus found that the two molten bodies ascend a little in the canal (because paraffin is not as dense as water), the geometry of the valve encouraging this ascent (FIGS. 3—P20) in the channel 360.
Upon cooling, this slight ascent of the bodies 350 is enough that when the air bubble 340 contracts, liquid from the reaction chamber 30 will fill the available space, leaving a goodly proportion of the meltable compound to solidify in the channel (FIGS. 3—P30).

At high temperature, which is to say above the melting-point temperature, as they are supernatant in the channels 360 above the reaction chamber 30, the bodies 350 present in the molten state make their own contribution to limiting the evaporation of the liquid.

At low temperature, which is to say below the melting-point temperature, after the heating of the chamber 30, the meltable compound returns to the solid-state and the bodies 350 completely seal off the various channels.

This type of valve mechanism 330 may notably be very useful for sealing off a reaction chamber 30 liable to experience temperature cycling in order to implement a detection reaction.

The principle of operation of the device 3 according to the first embodiment variant and of its two shared fluidic-valve mechanisms 33, 330, is explained hereinbelow in connection with FIGS. 4A to 4C.

The two mechanisms are incorporated into the one same fluidic component 1 in which the fluidic circuit supplies a reaction chamber 30. The two fluidic valve mechanisms are placed in the fluidic circuit comprising the two fluidic channels 36, 37 in series, the outlet fluidic channel 37 opening directly into said reaction chamber 30. The device 3 is thus intended to control fluidic access to the reaction chamber 30 via the fluidic circuit.

It should be noted that several other channels may open into the reaction chamber 30, notably another channel used for example in a vented fluidic circuit.

The reaction chamber 30 may hold at least some of the reagents needed for implementing the reaction.

The detection reaction performed in the chamber may notably be of biomolecular amplification type (PCR, LAMP . . . ) or may be of the immuno-enzymatic type (ELISA type).

It should be noted that analysis employing biomolecular amplification of microorganisms generally assumes the extraction the genetic material of the microorganisms. Various technical solutions may of course be employed in order to do that.

The principle of operation is described hereinbelow:
E1—FIG. 4A: The fluidic valve mechanisms of the device are in the open state, allowing the fluid to pass as far as the reaction chamber 30.
E2—FIG. 4B: The detection reaction is implemented in the reaction chamber 30. Conventionally, the reaction entails heating the chamber. The control module M2 therefore activates the heating module M1. The heating module M1 is activated, allowing the reaction chamber to be heated to a first temperature value T1 necessary for implementing the biochemical reaction. As indicated hereinabove, the heating to this first temperature value T1 is sufficient to cause:
   The expansion of the air present in the reservoir 32 in order to actuate the first fluidic valve mechanism 33 of the device and isolate the chamber during the reaction (valve 33 in state 0, and valve 330 in state 1);
   The expansion of the air bubble 340 and the melting of the meltable compound 350 used in the second fluidic valve mechanism 330 of the device;
Because the chamber 30 is isolated in the hot state by the closure of the first fluidic valve mechanism 33, the reaction can take place in the chamber 30. The temperature necessary for the reaction may be identical to the one necessary for isolating the chamber, allowing the two effects: reaction and chamber isolation, to be combined into a single activation of the heating module M1 to attain the desired temperature. The amplification reaction, for example of the PCR or equivalent type, may employ means capable of emitting an optical signal through the reaction chamber so that biological matter in the chamber 30 can be detected. The two bodies 350 made of meltable compound, are also driven, in the molten state, by the expansion of the air bubble 340, in the fluidic channel 36.
E3—FIG. 4C: Once the reaction has finished, the heating module M1 is deactivated or commanded to a temperature lower than said first temperature value T1. This leads to the release of the membrane 35 of the first fluidic valve mechanism 33 (33 at state 1) and to the cooling of the two bodies 350 made of meltable compound which are used for the second fluidic valve mechanism 330. The cooling continues down to a temperature of a value lower than said first temperature value T1. The bodies 350 made of meltable compound of the second fluidic valve 330 set and directly obstruct the fluidic channel 36 of the circuit, allowing the reaction chamber 30 to be sealed off (330 at state 0). The component 1 is therefore sealed off in a fluidtight manner, allowing it to be handled and transported.

In this context, the heating module M1 is thus intended to heat:
The reaction chamber 30;
The volume of air 38 used for actuating the first fluidic valve mechanism 33;
The air bubble 340 and the bodies 350 made of meltable compound of the second fluidic valve mechanism 330;

It is possible, with the one same heating source, to optimize the operation by altering the distribution of energy dissipation.

This then involves splitting the heating module into two resistive branches arranged in parallel or in series.

FIG. 6 illustrates this principle of splitting heating module M1 into two resistive branches B1, B2 in parallel.

The setup set out in these figures is that of two resistive branches B1, B2 in parallel, forming two distinct resistances connected in parallel with a power supply U. If the material and thickness of each branch are the same, which is simplest in terms of manufacture, their width can be varied, making it possible to obtain two distinct resistances (the wider the track the lower the resistance). The current in the first resistive branch B1 can be expressed as I₁=I×R₂/(R₁+R₂) where:
I is the current injected into the setup;
I₁ is the current passing through the first branch;
R₁ is the resistance of the first branch;
R₂ is the resistance of the second branch;

The power dissipated (through Joule-heating effect) in the first branch can be expressed as P₁=U×I₁=U×R₂/(R₁+R₂) where U is the voltage supplied by the control module M2. If the resistance R₁ is different from the resistance R₂ this power is different for the two branches and therefore the heating powers of the two branches of the heating means M1 are different.

By altering the resistance values, it is therefore possible to obtain more thermal power in one branch than in the other. For the same materials and material thicknesses, it is possible to increase the power dissipated in the widest branch, as shown in FIG. 6. FIG. 6 shows that the thermal power P1 emitted by the first branch B1 is higher than that (P2) emitted by the second branch B2 of the module. Thus, the temperature needed to activate the first fluidic valve mechanism 33 (to expand the volume of air 38) in order to seal off the reaction chamber 30 and initiate the second fluidic valve mechanism 330 (expand the air bubble 340 and melt the bodies 350) is attained more rapidly than the temperature needed for the reaction in the reaction chamber 30.

The same principle may be applied to two resistive branches in series.

This principle may of course be adapted to suit several branches in series, in parallel, or in series/parallel, in each case by altering the width of each track.

It is particularly advantageous to produce the heating module M1 on a thin film by deposition (sputtering, screenprinting, stencilling) It is thus possible to align the various branches precisely with the elements of the component to be heated and to choose the thermal power dissipated in each of the branches.

Thus, by virtue of this split heating module, the two valve mechanisms can operate in a way that is dependent on the reaction taking place in the reaction chamber 30. The closure of these two valve mechanisms may effectively occur before the temperature needed for the reaction in the reaction chamber 30 is attained, making it possible to avoid any contamination of the surroundings by accidental spillage and prevent the solution present in the reaction chamber from starting to evaporate while the temperature is increasing.

It should be noted that when the first valve mechanism 33 is closed, the pressure in the air volume 38 needs to be higher than the pressure in the reaction chamber 30, so as to withstand an overpressure (created for example by the reaction itself) in the reaction chamber 30. The temperature of the air contained in the air volume 38 leads therefore needs to be higher than the temperature present in the reaction chamber 30.

FIGS. 5A to 5C show the second embodiment variant of the device 4.

In this second embodiment variant, the sealing-off means collaborate with the actuating means capable of expanding, and use these actuating means in order to obtain the sealing-off. They are thus incorporated into the first fluidic valve 33 already described hereinabove, which comprises the fluidtight reservoir 32 filled with the volume of air 38 and the deformable membrane 35. The sealing-off means and the actuating means are incorporated into the component 10 supporting the fluidic circuit that is to be controlled.

The sealing-off means thus comprise a fluidic channel 620 opening at one end into the internal space of the reservoir 32, filled with the volume of air 38, and at the other end into a space 660 closed by the membrane 35. The device also initially comprises a body 650 made from a meltable compound initially obstructing this channel at its end that opens into the reservoir 32.

The principle of operation of the device 4 used for controlling fluidic access to a reaction chamber 30 is as follows:
Initially, at ambient temperature, which is to say below the melting-point temperature T1 for the meltable compound used, the body 650 obstructs the channel 620 and, in the absence of heat, the membrane 35 is initially in its open position, so that the fluid can circulate freely between the two channels 36, 37 (FIG. 5A—P100), thus allowing the reaction chamber 30 to be supplied.
The heating module M1 is activated, to heat the volume of air 38 to the temperature T1 allowing the volume of air 38 to expand and the body 650 made of meltable compound to melt. As it expands, the volume of air 38 pushes the molten body made of meltable compound toward the space 660 so that the body is deposited in the space 660 and on the deformed membrane 35 (FIG. 5B—P200). The expansion of the volume of air 38 also deforms the membrane 35 toward its closure position, obstructing the passage between the two channels 36, 37. Through its expansion, the volume of air 38 may have a tendency to press the meltable compound intimately against the external surface of the membrane 35.
After cooling, to the temperature T2 lower than the temperature T1, the meltable compound hardens and blocks and holds the membrane 35 in its closure position, indirectly allowing closure of the fluidic access and sealing-off of the reaction chamber 30 (FIG. 5C—P300). It thus prevents the membrane 35 from returning to its initial position.

In this second variant, the volume of air 38 acts as actuating means capable of expanding and allows the body 650 to be transferred from its standby position to its sealing-off position when it is in the molten state. It thus plays the same part as the air bubble 340 used in the second fluid valve 330 of the first variant of the device 3.

Nonlimitingly, the various fluidic elements of the device may be produced on the one same microfluidic component 1, 10. This component 1, 10 may be produced in the form of a microfluidic card formed of a stack of several layers. The stack may notably comprise two substrates each made from a material of the COP/COC (Cyclo Olefin Polymer/Cyclo Olefin Copolymer), polycarbonate type or of the PMMA (PolyMethyl MethAcrylate) type. It may notably exhibit transparency characteristics sufficient to allow optical reading when the analysis is performed directly in the component. A membrane common to the various modules of the component may be interposed between the two substrates. The membrane is formed of material that is very elastically deformable, allowing it to return to its initial shape following deformation. By way of example, the membrane may notably be made from materials such as elastomers from the family of silicones such as MQ (Methyl-Polysiloxanes), VMQ (Vinyl-Methyl-Polysiloxanes), PVMQ (Phenyl-Vinyl-Methyl-Polysiloxanes) or elastomers of the thermoplastic elastomer (TPE) type, for example TPE-S, TPS, TPE-E, TPC. It therefore acts as the deformable membrane that drives the elution fluid in the elution module and as the membranes used in the two valves for the hot isolation of the first access control device.

The various fluidic circuits of the component 1, 10, as well as the reaction chamber 30, may be produced by machining or some other method applied to one and/or both of the two substrates of the component.

The heating module M1 may be made up for example of one or more heating elements, of the resistance or Peltier-effect module type. The temperature of each heating element may be regulated independently. Advantageously, the heating module M1 may comprise a single heating element allowing the heating of the reaction chamber 30, the air reservoir 32, and making it possible to cause each body 350, 650 made of meltable compound to melt.

A temperature regulating system may be used to manage the heating temperature of the heating module M1. This system may comprise at least one temperature sensor and a control loop executed by the control module.

The heating module M1 may form part of an instrument/support onto which the component may be fitted.

Likewise, the control module M2 advantageously forms part of an above-mentioned instrument.

In order to create an entirely stand-alone marker, the heating module M1 may, however, be incorporated into the component or assembled therewith, the same being true of the control module M2. In that case, the system will need to comprise an electrical power supply such as an integrated battery.

1. A fluidic component, comprising:
a fluidic circuit having at least one fluidic access through which a fluid is intended to pass,
actuating means capable of expanding,
a deformable membrane that can be actuated by the expansion of said actuating means and that is configured to move between a first position in which it allows the fluid to pass through the fluidic access and a closure second position in which it blocks the passage of the fluid through the fluidic access,
sealing means for sealing off the fluidic access and comprising at least a body made of a meltable compound configured to adopt two states:
a solid first state,
a molten second state obtained under the effect of an increase in temperature,
said body of meltable compound being designed to be moved in the molten state, by the expansion of the actuating means, between a standby position and a distinct sealing-off position for sealing off the fluidic access.

2. The component according to claim 1, wherein the actuating means capable of expanding comprise a fluidtight reservoir filled with a volume of air collaborating via a fluidic passage with the membrane.

3. The component according to claim 1, wherein the actuating means comprise a bubble of gas able to expand and trapped in a location by said body made of meltable compound.

4. The component according to claim 2, wherein the fluidic passage is initially blocked by the body made of meltable compound present in its solid first state and in its standby position.

5. The component according to claim 4, wherein, in its sealing-off position, the body made of meltable compound is deposited on a face of the membrane which is the opposite face to a face that closes off the fluidic access.

6. The component according to claim 1, wherein the component is produced in the form of a one-piece element.

7. The component according to claim 1, wherein the membrane is produced from a material of the elastomer type.

8. The component according to claim 1, wherein the meltable compound is a paraffin selected from docosane, tricosane, tetracosane, pentacosane, hexacosane and octacosane.

9. A fluidic device comprising:
a fluidic component as defined in claim 1,
heating means designed to:
heat said body made of meltable compound to a temperature sufficient to cause it to pass from its first state to its second state
expand said actuating means, causing the membrane to deform from its first position to its second position and causing the body made of meltable compound to move, in its second state, toward the position for sealing off the fluidic access.

10. The fluidic device according to claim 9, wherein the fluidic circuit comprises a reaction chamber and wherein the heating means are designed to perform heating both of:
said reaction chamber in order to perform a detection reaction, and
of said body made of meltable compound to a temperature sufficient to cause it to pass from its first state to its second state,
and to expand said actuating means, causing the membrane to deform from its first position to its second position and causing the body made of meltable compound to move, in its second state, toward the position for sealing off the fluidic access.

11. The device according to claim 9, wherein the heating module comprises at least two resistive branches in parallel, each one configured to exhibit a distinct electrical resistance, the first branch being dedicated to providing a first thermal power and the second branch dedicated to supplying a second thermal power, said first thermal power being higher than the second thermal power.

12. The device according to claim 9, wherein the heating module comprises at least two resistive branches in series, each one configured to exhibit a distinct electrical resistance, the first branch being dedicated to providing a first thermal power and the second branch dedicated to supplying a second thermal power, distinct from the first thermal power.

13. An analysis method implemented in a fluidic device as defined in claim 9, wherein the method comprises activating the heating means to a temperature sufficient to at once:
implement a detection reaction in said reaction chamber,
actuate the membrane toward its closure position in order to isolate the reaction chamber during said detection reaction,
initiate a sealing-off of the reaction chamber by the melting of the body made of meltable compound and the movement of said body in the molten state toward its sealing-off position.
